(19) United States
(12) Patent Application Publication
(10) Pub. No.: US 2005/0182816 A1
(43) Pub. Date: Aug. 18, 2005

(54) Automated dissemination of presence and availability schedule

(76) Inventors: Wanrong Lin, Princeton, NJ (US); Alan Kaplan, Princeton, NJ (US); Mahfuzur Rahman, South Brunswick, NJ (US); Jay Gopal, Plainsboro, NJ (US); Dennis Bushmitch, Somerset, NJ (US); Deanna Wilkes-Gibbs, Palo Alto, CA (US)

Correspondence Address: HARNESS, DICKEY & PIERCE, P.L.C., P.O. BOX 828, BLOOMFIELD HILLS, MI, 48303, US

(21) Appl. No.: 10/777,905

(22) Filed: Feb. 12, 2004

(51) Int. Cl. G06F 9/46

(52) U.S. Cl. 709/200

(57) ABSTRACT

Presence and availability information is disseminated through a computer system architecture having four interactive elements. A schedule publication element acquires information about user schedules. A schedule management element communicates with the publication element to acquire schedule information and to store integrated schedule information in a storage system. A schedule distribution element acquires schedule information from the schedule management element and selectively disseminates the information to subscribers who have interacted with a schedule subscribing element. Both current and future presence and availability information is thus collected and disseminated in an orderly manner.

### BACKGROUND OF THE INVENTION

The present invention relates generally to instant messaging systems and scheduling systems. More particularly, the invention relates to improvements in instant messaging and presence (IM&P) protocols and systems for implementing those improved protocols.

The Internet Engineering Task Force (IETF) has promulgated certain standards and protocols for implementing instant messaging and presence (IM&P) services over the internet. The presently existing IM&P protocols focus on the user's real-time presence and availability status. In many cases, it would be useful for subscribers to know the future presence and availability statuses of those people with whom they wish to have communications. People can plan their communications more efficiently with that sort of information. However, the current standards and protocols for implementing IM&P do not provide an architecture through which this can be accomplished.

### SUMMARY OF THE INVENTION

The present invention provides an architecture, comprised of plural elements, through which a user can disseminate his or her presence and availability schedule in an automatic and controlled manner to users who subscribe to that information. In accordance with one aspect of the invention, a system for automated dissemination of presence and availability information is provided. The system employs a schedule publication element configured to acquire schedule information associated with at least one user; a schedule management element configured to receive schedule information from said schedule publication element and having storage system configured to store integrated schedule information based on said received schedule information; a schedule subscribing element configured to provide registration services whereby a subscriber registers to receive notifications regarding presence and availability information; and a schedule distribution element receptive of said integrated schedule information from said schedule management element and being responsive to said schedule subscribing element to maintain a data store identifying those subscribers who have registered to receive notifications regarding presence and availability information and to effect the dissemination of presence and availability to said subscribers.

These elements can be implemented as separate software components and/or modules, or they may be combined into one or more multifunction groups. Interaction among elements may be carried out through network connections. Other possible means for such interactions include programming interfaces.

For a more complete understanding of the invention, it's objects and advantages, references may be had to the remaining specification and to the accompanying drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a system block diagram illustrating the automated dissemination of presence and availability schedule architecture and it's principal elements.

### DETAILED DESCRIPTION OF THE PREFERRED EMBODIMENTS

The following description of the preferred embodiment(s) is merely exemplary in nature and is in no way intended to limit the invention, its application, or uses.

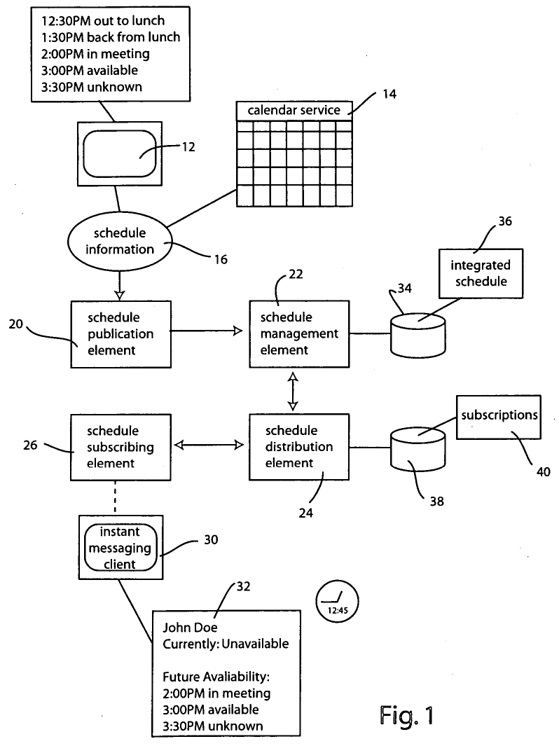

Referring to FIG. 1, the automated dissemination of presence and availability schedule will now be discussed in connection with a first presently preferred architecture. As used herein, a user's future presence and availability information is referred to as presence and availability schedule (or simply schedule).

An example of such a schedule is illustrated at 10 in FIG. 1. This example is intended merely to teach concepts useful in implementing the invention. Other types of schedules, potentially including other types of information, are also possible. For example, the schedule can also indicate the contact means by which the user is available for any one or more of the schedule item entries.

Typically a user may enter his or her schedule into a computer system using suitable schedule management software either running on the user's personal computer or running on another computer that is accessed via a communication link such as a computer network or the internet. In the former case, the user typically enters schedule items through a user interface generated by or mediated by a software application running on the user's personal computer. In the latter case, the user will typically interact with a scheduling server through a suitable browser interface, such as a web browser interface, by which the user supplies scheduling information to the server.

For purposes of illustration in FIG. 1, a user interface screen 12 has been depicted. It will be understood that this user interface screen 12 may be either generated by an application program running on the user's personal computer or by another computer with which the user communicates via a suitable browser. Such input by the user through a user interface is one way by which a user's schedule information can be generated for use by the automated dissemination of presence and availability schedule system. It is not the only way, however.

In another presently preferred embodiment, schedule information may be developed by accessing a calendar service 14. In one form, the calendar service may be implemented as an enterprise-wide system for coordinating time and activities of a company or group. Often such calendar services provide an internet portal with which the user can gain access to the system via the internet. According to the present invention the system is capable of accessing such calendar services, such as by connecting through the portal, and deducing the user's schedule information from the calendar service.

Collectively, schedule information supplied by the user to a suitable human interface such as screen 12, and schedule information extracted or deduced from a calendar service, as well as other potential sources of schedule information form one basic input to the automated dissemination of presence and availability schedule system. Accordingly, in FIG. 1, this body of schedule information has been depicted at 16. It will be understood that such schedule information 16 can come from a variety of sources, such as those illustrated in FIG. 1.

A presently preferred architecture for implementing the automated dissemination of presence and availability schedule system is shown in FIG. 1 as including four elements: schedule publication element 20, schedule management element 22, schedule distribution element 24 and schedule subscribing element 26. These four elements work together to process schedule information 16 to permit instant messaging clients, such as client 30 to ascertain the user's presence and availability schedule. As illustrated diagrammatically at 32, the ascertained schedule provides information about the user's current availability and also future availability. For illustration purposes assume that the current time is 12:45 p.m. The system would ascertain in this case that the user (John Doe) is currently unavailable, but would be available in the future at 1:30 p.m.-2:00 p.m. and 3:00 p.m.-3:30 p.m. This information is based on the schedule 10 provided by user John Doe.

The four elements that make up the architecture of the system can be implemented either as separate systems, running on separate servers, or one or more of the elements can be implemented as a single system, such as on a single server or cluster of related servers. The architecture illustrated in FIG. 1 is thus a logical architecture which can be implemented in a variety of different ways using various physical and software components depending on the application requirements.

The schedule publication element is responsible for creating schedules or schedule updates. It is further responsible for publishing such created schedules or schedule updates to the schedule management element 22. The source of schedule information 16 is not limited (as discussed above). Schedule publication element 20 may acquire schedule information from the user, through a human interface, such as interface 12. It may also deduce the schedule information from a calendar service, such as calendar service 14. Schedule publication element 20 interacts with the schedule management element 22 to transfer and/or publish the schedule information to it.

The schedule management element 22 is responsible for storing, updating and providing access to schedules. The schedule management element thus has an associated data store 34 in which the integrated schedules of users are stored, as illustrated diagrammatically at 36. The schedule management element receives schedule information (new schedule, schedule updates) from schedule publication elements, such as element 20, and maintains an integrated schedule 36. The schedule management element also provides an interface through which a schedule distribution element 24 can access the schedule and receive notifications if the schedule changes. The interface 50 may be implemented to provide two-way access, thereby allowing the schedule distribution element 24 to request (pull) information from the schedule management element 22, and also to allow the schedule management element 22 independently distribute (push) information to the schedule distribution element 24.

The schedule distribution element 24 is responsible for distributing schedule information to the users (subscribers) who subscribe to a presentity's presence and availability status. This element accesses the schedule information stored in a schedule management element and automatically sends schedule information notifications to the subscribers. The presentity and the subscribers can interact with the schedule distribution element to control the manner in which the schedule information is distributed.

The schedule distribution element includes a data store 38 for storing subscriber information 40 about subscribers who have registered to receive schedule information. Data store maintains records of the identify of subscribers in association with information about whose schedules are being subscribed to, along with preference information describing what schedule information is to be disseminated and in what manner.

Based on the amount of schedule information allowed to release, the schedule distribution element 24 can distribute the schedule information in a number of different modes.

In the open mode the whole schedule is open to the subscribers. The schedule distribution element sends updates to the subscribers whenever the schedule is updated by the schedule publication element. In the sliding-window mode only a portion of the schedule defined by a sliding window is open to the subscribers. The rear end of the window is the present time. The size of the window can be a period of time, or the number of future status changes in the schedule. While the sliding window moves, it's front end encounters status changes in the schedule and the schedule distribution element sends notifications to the subscribers with the changed contents in the schedule window.

Based on the manner in which notifications are created, the schedule distribution element can distribute the schedule information in the following modes:

In the amendment mode, only the changes in the schedule portion allowed to release are in the notifications. In the refreshment mode, all the schedule information allowed to release is in the notifications.

When a subscription for schedule information is established, a refreshment mode notification is preferably sent. After that, the schedule distribution element can use either mode, based on rules, policies or the subscribers' requests.

The scheduling element 26 is responsible for establishing subscriptions for schedule information. A request is conveyed by this element to a schedule distribution element 24 for such purpose. In the request, the schedule subscribing element can designate the presentity and detail it's preferences on the subscription. The schedule distribution element would decide whether to accept the subscription. The schedule distribution element may also accept the subscription without satisfying all the preferences in the subscription request.

The interactions among the elements described above may be carried out through network connections. Other possible means for such interactions include programming interfaces.

The description of the invention is merely exemplary in nature and, thus, variations that do not depart from the gist of the invention are intended to be within the scope of the invention. Such variations are not to be regarded as a departure from the spirit and scope of the invention.

1. A system for automated dissemination of presence and availability information, comprising:
a schedule publication element configured to acquire schedule information associated with at least one user;
a schedule management element configured to receive schedule information from said schedule publication element and having storage system configured to store integrated schedule information based on said received schedule information;
a schedule subscribing element configured to provide registration services whereby a subscriber registers to receive notifications regarding presence and availability information;
a schedule distribution element receptive of said integrated schedule information from said schedule management element and being responsive to said schedule subscribing element to maintain a data store identifying those subscribers who have registered to receive notifications regarding presence and availability information and to effect the dissemination of presence and availability to said subscribers.

2. The system of claim 1 wherein said system disseminates presence and availability information to an instant messaging client.

3. The system of claim 1 wherein said schedule publication element provides a human interface through which said user inputs schedule information.

4. The system of claim 1 wherein said schedule publication element is adapted to obtain schedule information from a calendar service.

5. The system of claim 1 wherein said schedule management element communicates with said schedule distribution element using a push interface whereby information retrieved from said storage system is automatically sent to said schedule distribution element.

6. The system of claim 1 wherein said schedule management element communicates with said schedule distribution element using a pull interface whereby information retrieved from said storage system is sent to said schedule distribution element at the request of said said schedule distribution element.

7. The system of claim 1 wherein said schedule distribution element controls the dissemination of presence and availability information in an open mode whereby a user's entire schedule is made available to subscribers.

8. The system of claim 7 wherein said schedule distribution element in said open mode sends updates to said subscribers whenever the user's schedule is updated by said schedule publishing element.

9. The system of claim 1 wherein said schedule distribution element controls the dissemination of presence and availability information in a sliding-window mode whereby a predefined portion of a user's schedule is made available to subscribers.

10. The system of claim 9 wherein said predefined portion is defined by a sliding window measured from the present time until a predetermined period of time thereafter.

11. The system of claim 9 wherein said predefined portion is defined by a sliding window measured from the present time and including a predetermined number of future status changes in said schedule.

12. The system of claim 9 wherein said schedule distribution element is configured to send notification to subscribers of schedule change information when said sliding window encounters status changes in the user's schedule.

13. The system of claim 1 wherein said schedule distribution element controls the dissemination of presence and availability information in an amendment mode whereby only the changes in a predetermined portion of said schedule are disseminated.

14. The system of claim 1 wherein said schedule distribution element controls the dissemination of presence and availability information in an refreshment mode whereby all schedule information in a predetermined portion of said schedule is disseminated.

15. The system of claim 1 wherein said schedule subscribing element communicates with said schedule distribution element to negotiate whether to accept a subscription request.

16. The system of claim 15 wherein said schedule distribution element controls whether to accept a subscription request.

17. The system of claim 1 wherein said subscription request identifies preferences associated with a given subscriber that mediate how information is disseminated to that subscriber.

18. The system of claim 17 wherein said preferences are stored in said data store identifying those subscribers who have registered to receive notifications.

19. The system of claim 17 wherein said schedule distribution element is configured to selectively accept a subscription request even if the identified preferences are not met.

20. The system of claim 1 wherein at least some of said elements are interactive with one another via network communication.

21. The system of claim 1 wherein at least some of said elements are interactive with one another via programming interfaces.
